(19) United States
(12) Patent Application Publication
(10) Pub. No.: US 2015/0067640 A1
(43) Pub. Date: Mar. 5, 2015

(54) INPUT SUGGESTIONS FOR FREE-FORM TEXT ENTRY

(71) Applicant: The MathWorks, Inc., Natick, MA (US)

(72) Inventors: John E. Booker, Jamaica Plain, MA (US); Richard M. Mckeever, Springfield, MA (US); Aaron J. Powers, Wayland, MA (US)

(73) Assignee: The MathWorks, Inc., Natick, MA (US)

(21) Appl. No.: 14/013,868

(22) Filed: Aug. 29, 2013

(51) Int. Cl. G06F 9/44

(52) U.S. Cl. CPC G06F 8/34
USPC 717/109

(57) ABSTRACT

In an embodiment, a method allows interacting with a textual programming language in a development environment. The development environment includes a first field and a second field related to the first field. An entry for the first field is received at the development environment. One or more required programming structure attributes for the second field are determined based on the entry for the first field. A first GUI of one or more input suggestions for the second field is generated. The one or more input suggestions for the second field comply with the one or more required programming structure attributes for the second field. The first GUI is displayed in connection with the textual programming language to illustrate one or more input suggestions for the second field.

### BRIEF DESCRIPTION OF THE DRAWINGS

The accompanying drawings, which are incorporated in and constitute a part of this specification, illustrate one or more embodiments of the invention and, together with the description, explain the invention. In the drawings:

FIG. 1A depicts a diagram of an overview of an example implementation described herein;

FIG. 1B depicts a diagram of an overview of another example implementation described herein;

FIG. 1C depicts a diagram of an overview of an example implementation using a mathematical language described herein;

FIG. 2A depicts an exemplary development environment;

FIG. 2B depicts an exemplary logic associated with the exemplary development environment of FIG. 2A;

FIG. 3A illustrates the details of an exemplary library of FIG. 2B;

FIG. 3B depicts an exemplary flowchart illustrating processing acts for generating and displaying an input suggestion using the exemplary library of FIG. 3A;

FIG. 4A illustrates the details of an exemplary database of FIG. 2B;

FIG. 4B depicts an exemplary flowchart illustrating processing acts for generating and displaying an input suggestion using the exemplary database of FIG. 4A;

FIG. 5A depicts an exemplary development environment providing a first graphical user interface (GUI) of input suggestions in connection with a textual programming language;

FIG. 5B depicts the exemplary development environment of FIG. 5A providing a second GUI of input suggestions in connection with the textual programming language;

FIG. 5C depicts the exemplary development environment of FIG. 5A providing a third GUI of input suggestions in connection with the textual programming language;

FIG. 6A depicts a GUI providing one or more backward input suggestions in an exemplary development environment;

FIG. 6B depicts the exemplary development environment of FIG. 6A where an entry in the field is replaced with one of the one or more backward input suggestions;

FIG. 6C depicts an exemplary flowchart illustrating processing acts for generating and displaying a backward input suggestion for use with a textual programming language;

FIG. 7A depicts a first GUI providing explanation of input requirements for a selected programming structure in an exemplary development environment;

FIG. 7B depicts a second GUI of input suggestions in connection with the selected programming structure illustrated in FIG. 7A;

FIG. 8 depicts two separate GUIs of input suggestions displayed in connection with a programming structure provided in an exemplary development environment;

FIG. 9 depicts an example of an electronic device suitable for practicing an exemplary embodiment; and

FIG. 10 depicts an exemplary distributed system suitable for practicing an exemplary embodiment.

### DETAILED DESCRIPTION

According to various embodiments, one or more input suggestions used in connection with a textual programming language are presented in a development environment using a graphical user interface (GUI). The GUI may provide one or more input suggestions. However for ease of presentation, the remainder of the detailed description refers to a single input suggestion.

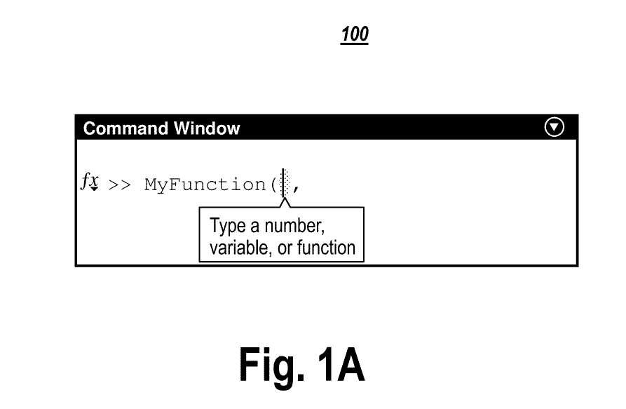

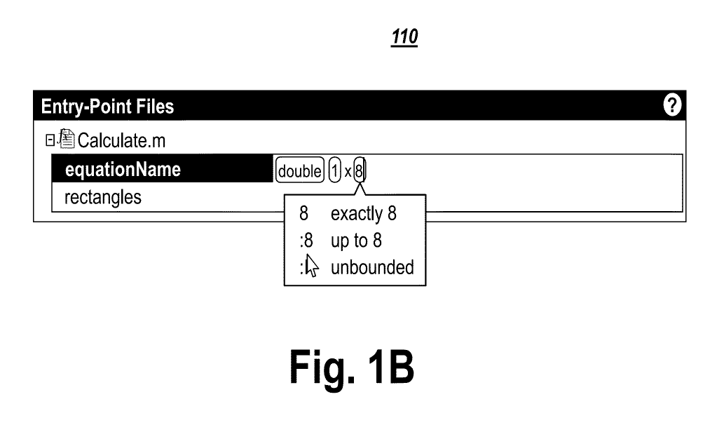

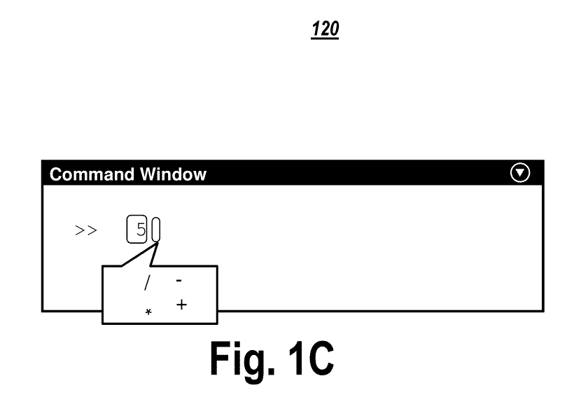

FIG. 1A illustrates a diagram of an overview of an example implementation 100 described herein. A portion of an exemplary development environment, such as an interface, is illustrated in FIG. 1A. In some embodiments, the interface may be provided in a spreadsheet application. According to various embodiments, the interface can include a command-line interface (CLI). The CLI may be a command window for receiving typed programming code from a user of a textual programming language.

An entry, such as a function name “Myfunction” may be provided at a first cursor location on the CLI. According to programming structure requirements of the textual programming language, the function “Myfunction” may require two inputs, e.g. two arguments. A portion of the CLI associated with the function name may be structured according to the required arguments. For example, as illustrated in FIG. 1A, the portion of the CLI following the function name “Myfunction” is structured to display two fields into which function arguments may be entered.

A first field may be activated, for example by selecting the first field using a pointing device, or automatically upon typing the function name “Myfunction”. Activating the first field may cause a GUI, such as a pop-up window, to be displayed. The popup window may provide an input suggestion for the first field. For example, the pop-up window may indicate that a number, a variable or a function may be entered in the first field.

Items provided in the pop-up window may be determined based on the function name “Myfunction” and programming structure requirements of the textual programming language.

FIG. 1B illustrates an overview of another example implementation 110 described herein. A portion of an exemplary development environment, such as an interface, is illustrated in FIG. 1B. The interface may include a CLI. The CLI may be used for receiving variables for a given function and/or equation. As illustrated in FIG. 1B, a user may have provided inputs in the fields “double” “1” and “8”. Providing a user entry for a field may cause a GUI, such as a pop-up window, to be displayed. The popup window may provide a backward input suggestion for replacing an entry in the field. The backward input suggestion may be provided to present possible alternatives to the user entry. For example, in FIG. 1B, when the user enters “8” in the last field, the GUI provides three backward input suggestions: “exactly 8”, “up to 8” and “unbounded”. If the user selects the backward input suggestion, the entry may be replaced with the selected backward input suggestion (e.g., the user may select “exactly 8”). In some embodiments, the backward input suggestion may be provided when the user entry fails to comply with programming structure requirements of the programming language.

FIG. 1C illustrates an overview of an example implementation 120 where the textual programming language is a mathematical language. Programming structure requirements of the mathematical language may only accept certain inputs as being valid. For example, a user may be limited in what can be entered after a numerical entry. For example, when the user provides a free form entry by typing “5” followed by a space, logic (e.g., a parser) associated with the development environment may parse the user entry. Upon parsing, the logic may determine that the programming structure requirements of the mathematical language may only allow entry of mathematical operators such as addition “+”, subtraction “−”, multiplication “*” or division “/”. Accordingly, the input suggestions for the second field, e.g. the plurality of mathematical operators, may be provided even when the second field does not contain an entry, such as an entry provided by a user.

In the example illustrated in FIG. 1C, the user may be prevented from typing another number as the mathematical language may require a symbol to join two adjacent numbers separated by a space. Embodiments discussed herein may display acceptable input suggestions, such as a list of the mathematical operators, in a GUI, e.g. a pop-up window.

Exemplary embodiments may be useful in developing programming language code in a development environment using, for example, the CLI illustrated in FIGS. 1A-1C. The textual programming language associated with the CLI of FIGS. 1A-1C may accept free-form text entries that include one or more characters including letters, numbers and/or symbols. The logic associated with the development environment may parse free-form text entries. Upon parsing the user entry, the logic may determine one or more valid programming structures that may follow the user entry based on the syntax rules of the textual programming language. Valid programming structures can be provided as input suggestions using a GUI.

Input suggestions may improve programming efficiency by reducing programming time and preventing coding mistakes during editing of the code. According to various embodiments, the editing of code may include creating and/or generating new code or making edits to existing code. Exemplary embodiments may also be used when previously generated code is executed. For example, a user input may be required when previously generated code is executing. When this is required, embodiments may provide an input suggestion to indicate what type of input is expected from the user. More generally, the input suggestions described herein may be used in connection with the development environment any time an input is to be received from a user.

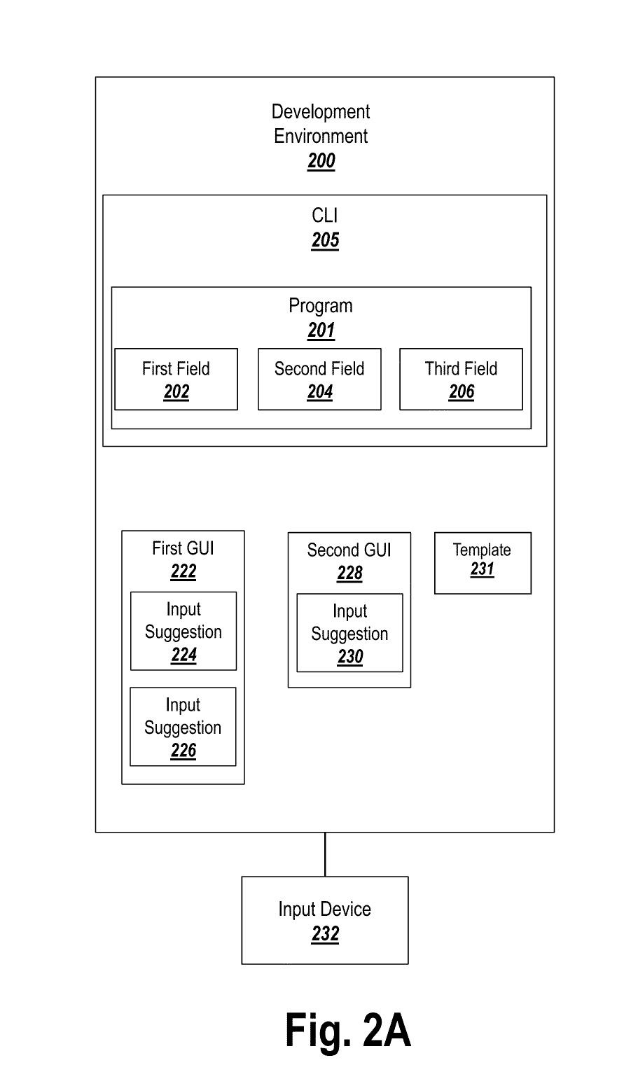

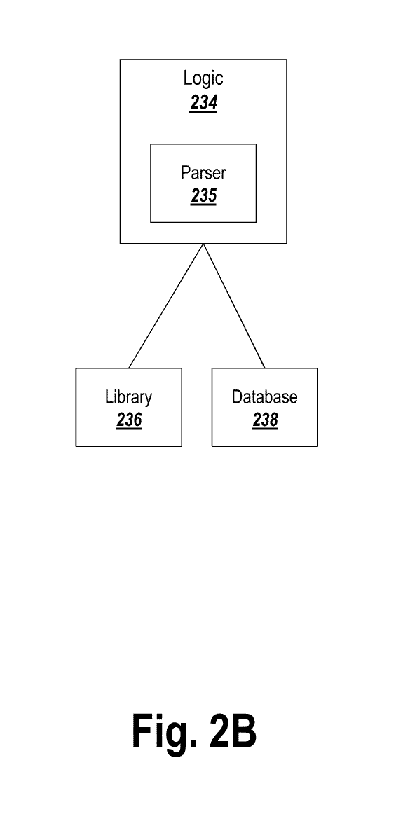

FIG. 2A illustrates an exemplary development environment 200. A program 201 may be generated using a textual programming language, a graphical programming language, or a hybrid environment combining textual and graphical programming languages, associated with development environment 200. In various embodiments, development environment 200 may include an application, including but not limited to a technical computing application, a spreadsheet application, a word-processing application, a network application, a web-based application, a data management application, etc. The program 201 may be generated using the application.

Development environment 200 may provide a command-line interface (CLI) 205 with one or more fields, such as fields 202, 204 and 206. One of ordinary skill in the art will appreciate that fields 202, 204 and 206 are provided for illustration purposes and that command window 205 may include any number of fields. However for ease of presentation, the remainder of the detailed description refers to a single field 202 unless otherwise noted.

A cursor location may correspond to a field in development environment 200 where free-form text may be entered. A field in development environment 200 may be a location that accepts a free-form textual entry, such as a window. A free-form text entry may include a sequence of one or more characters including letters, numbers and/or symbols. Based on the free-form text entry provided in a field, embodiments may generate and display an input suggestion for a given cursor location associated with the field. For example, the input suggestions may be new entries for the given cursor location. Locations related to user inputs and/or to input suggestions are generally referred to as cursor locations unless otherwise noted.

Input device 232 may be used to identify (e.g., point to) a location of CLI 205 and to provide textual input to CLI 205. A location of CLI 205 that accepts textual entry may be considered as being equivalent to a field. Field 202 may be an explicit field, i.e. displayed with visible demarcation lines in CLI 205. In various embodiments, field 202 may be an implicit field, i.e. not displayed with visible demarcation lines.

According to various embodiments, field 202 may be part of program 201. Development environment 200 may further support one or more templates 231 that may be used in connection with program 201.

According to various embodiments, field 202 may be related to other fields. That is, a user entry in first field 202 may impose, in second field 204 and/or third field 206, one or more programming structure requirements (PSR) associated with the textual programming language. For example, when the user entry is provided for first field 202, a first GUI 222 that includes input suggestions 224, 226 may be provided for second field 204. According to various embodiments, first GUI 222 may include a list of input suggestions 224, 226 or a graphical representation of input suggestions 224, 226.

FIG. 2B illustrates exemplary logic 234 associated with development environment 200 of FIG. 2A. In some embodiments, logic 234 may be a part of development environment 200. Alternatively, logic 234 may be incorporated in an execution engine associated with development environment 200. Logic 234 may be programmed to work with a syntax of the textual programming language and hence may have access to the PSR of the textual programming language of development environment 200, such as the syntax rules and/or constraints applicable to the user code generated.

Upon receiving the user entry in first field 202, logic 234 may determine one or more programming structure attributes for second field 204 based on the PSR of the textual programming language. Logic 234 may be programmed to work with the textual programming language. For example, logic 234 may know the PSR of the textual programming language, such as syntax rules and constraints. Logic 234 may be implemented as hardware based logic, software based logic and/or logic that is a combination of hardware and software based logic (e.g., hybrid logic).

Logic 234 may include parser 235. When a user entry is provided in first field 202 of CLI 205, logic 234 may parse the user entry using parser 235. For example, parser 235 may parse the entry from left to right, in a same direction that the entry is provided, etc.

In some embodiments, logic 234 may employ artificial intelligence algorithms to determine an input suggestion associated with development environment 200. For example, logic 234 may learn a selection algorithm from previous user entries and determine the input suggestion based on the learned behavior.

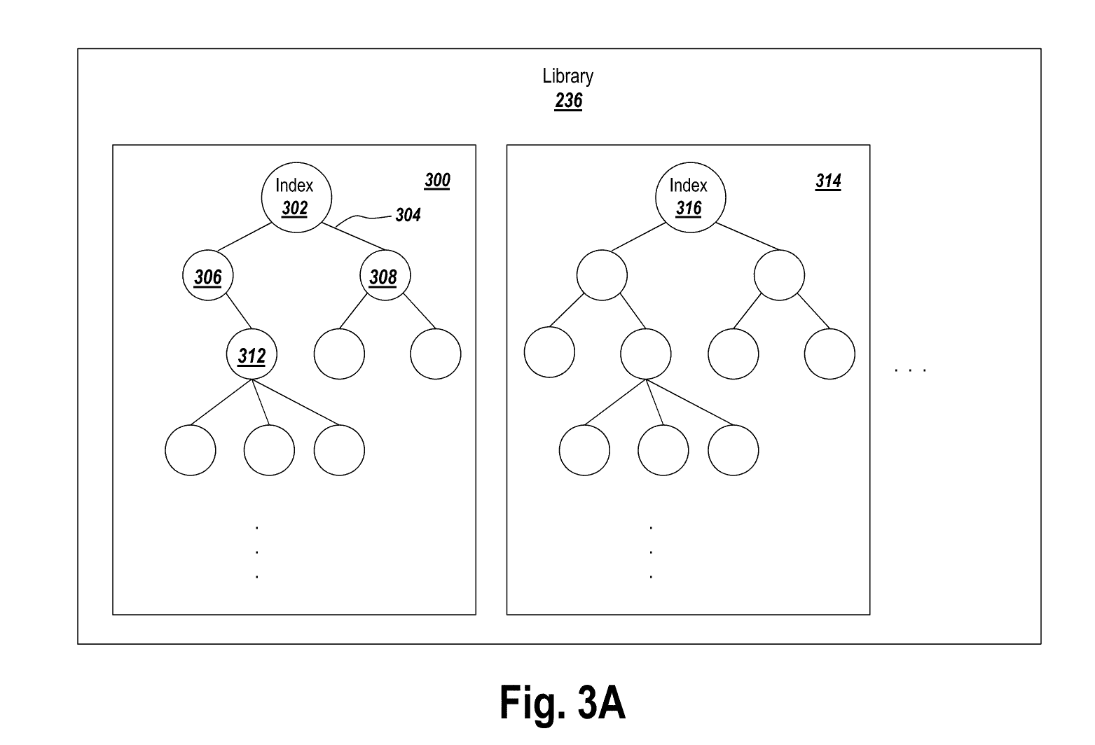

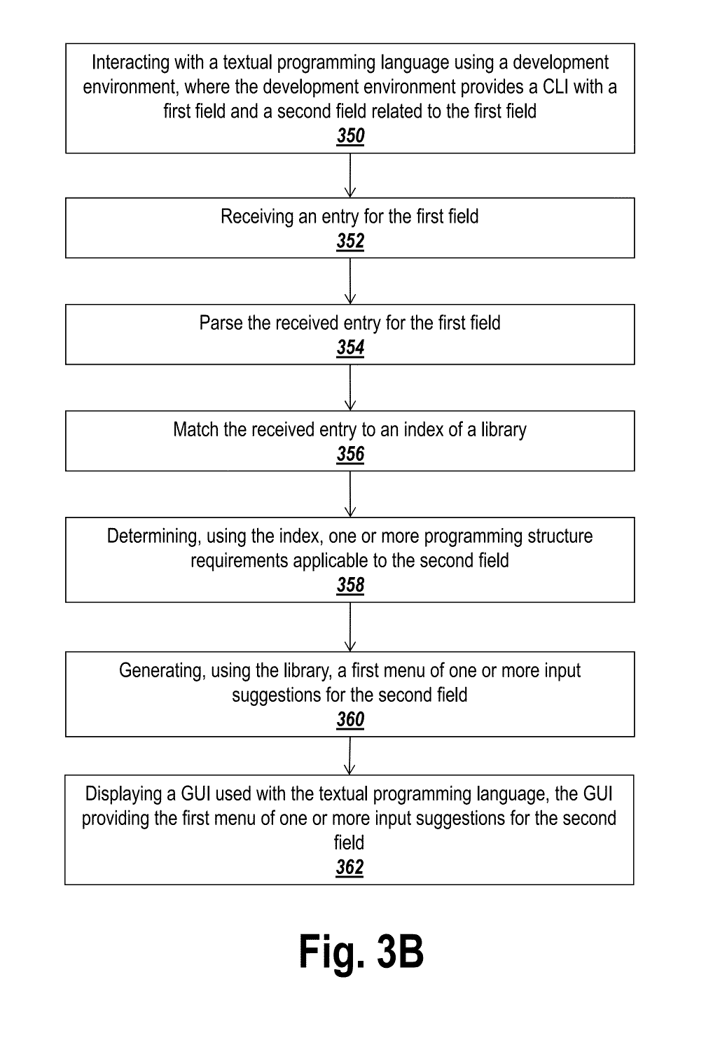

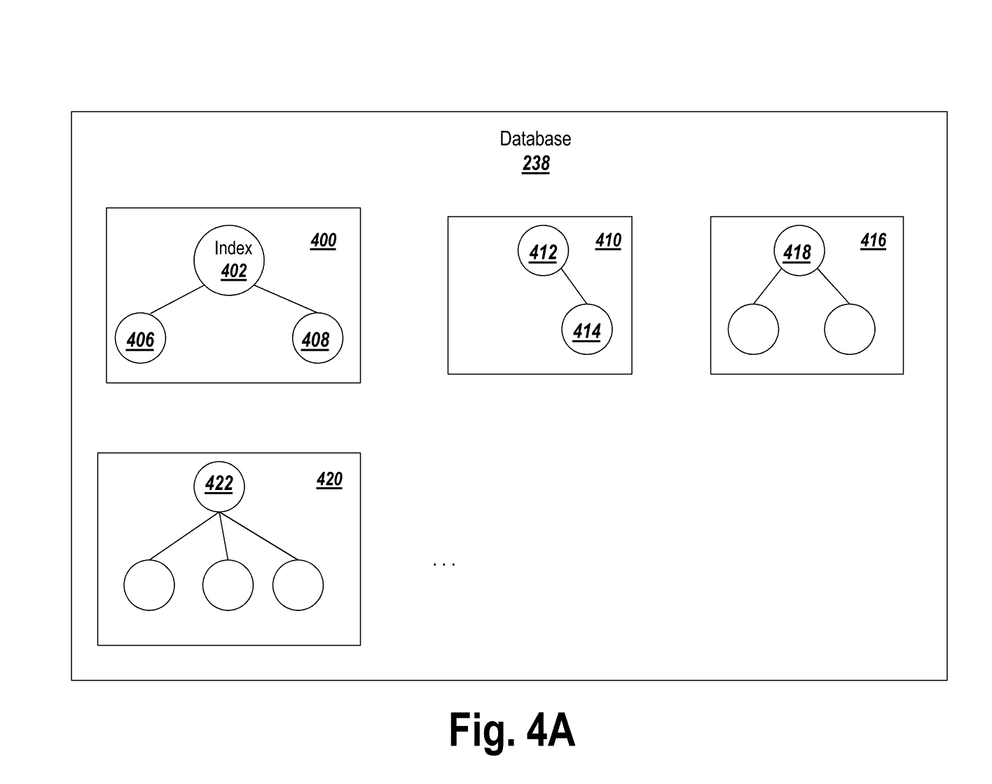

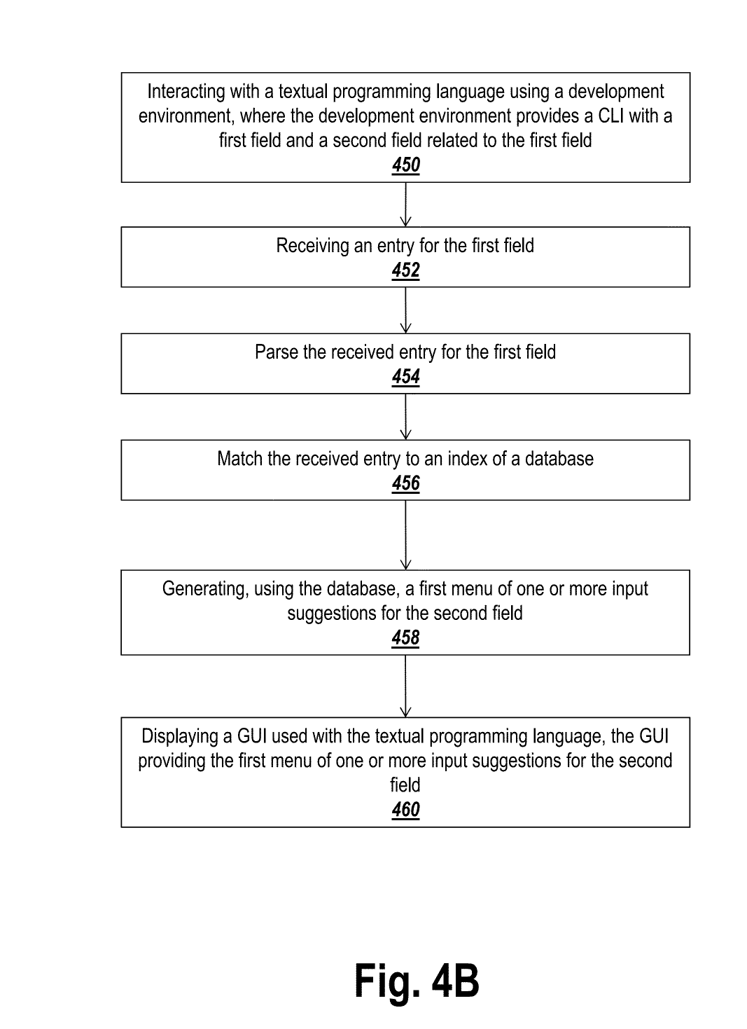

In some embodiments, logic 234 may be associated with a library 236 and/or a database 238. The details of library 236 are illustrated in FIG. 3A. The details of database 238 are illustrated in FIG. 4A.

As illustrated in FIG. 3A, library 236 may store one or more library entries 300, 314. One of ordinary skill in the art will appreciate that library entries 300, 314 are provided for illustration purposes and that library 236 may include any number of library entries. Library entry 314 may include a similar or identical arrangement to library entry 300 discussed below. According to various embodiments, one or more library entries may be added to or deleted from library 236. For ease of presentation, the remainder of the detailed description refers to a library entry 300.

Library entry 300 may include a tree structure illustrating the relationships among one or more data structures making up entry 300. Entry 300 may include an index 302, which is a data structure that constitutes a first element of the tree structure in entry 300. Library entry 300 may also include any number of PSR 304 of the textual programming language. PSR 304 may be applicable to the data structures of entry 300.

FIG. 3B illustrates an exemplary flowchart illustrating processing acts for generating and displaying input suggestions using library 236. Processing acts of FIG. 3B are further described by referencing the components of development environment 200 and logic 234 illustrated in FIGS. 2A, 2B and 3A.

As provided in FIG. 3B, a user may interact with a textual programming language using development environment 200. Development environment 200 may provide CLI 205 including a first field 202 and a second field 204, where the second field 204 is related to the first field 202 (block 350). A user entry for the first field 202 may be received at CLI 205 (block 352). Logic 234 may parse the user entry for the first field 202 using parser 235 (block 354). Upon parsing the user entry, logic 234 may match the user entry to an index 302 in library 236 (block 356). When a match between the user entry and an index is identified, logic 234 may determine programming structure attributes of second field 204 based on PSR 304 of the textual programming language (block 358).

For example, if logic 234 determines that the user entry in first field 202 is equivalent to index 302 of entry 300, logic 234 may retrieve entry 300 from library 236. Library entry 300 indicates that PSR 304 is associated with index 302 and applicable to second field 204. Using index 302 and PSR 304, logic 234 may determine that data structures 306, 308 may be entered in second field 204. Thus, logic 234 may generate a first menu including input suggestions 224, 226 for the second field 204 (block 360). The first menu of input suggestions may include data structures 306, 308. A first GUI 222 of input suggestions 224, 226 for second field 204 may be displayed on development environment 200 (block 362).

In some embodiments, at least one of the input suggestions 224, 226 displayed using first GUI 222 may be selected via input device 232. The selected input suggestion may be entered into second field 204. Alternatively, a free-form text entry for second field 204 may be provided via input device 232, discarding the input suggestions 224, 226 provided on first GUI 222.

According to various embodiments, the input suggestion for the second field may be generated while the second field does not contain an entry, i.e. while the second field is empty. For example, first GUI 222 may be displayed even when there is no entry in second field 204, i.e. when second field 204 is empty.

If the user selects one of input suggestions 224, 226 for second field 204, logic 234 may apply the next set of PSR of the textual programming language to the user selected input suggestion. If there exists a third field 206 associated with second field 204, logic 234 may format third field 206 according to the PSR of the textual programming language and as imposed by the entry in at least second field 204.

Second GUI 228 including input suggestion 230 may be provided for third field 206. Input suggestion 230 may comply with the programming structure attributes of third field 206 as required by PSR of programming language, the entry in second field 204 and/or first field 202. Second GUI 228 may be displayed even when no entry is present in third field 206, i.e. when third field 206 is empty. In some embodiments, second GUI 228 may be displayed when an entry for third field 206 is received via input device 232. Input suggestion 230 provided on second GUI 228 may be selected such that input suggestion 230 is entered into third field 206. Alternatively, a free-form text entry for third field 206 may be provided via input device 232, discarding input suggestion 230 provided on second GUI 228.

In some embodiments, the input suggestions may be generated using a database. FIG. 4A illustrates database 238 storing database entries 400, 410, 416, 420. One of ordinary skill in the art will appreciate that database entries 400, 410, 416, 420 are provided for illustration purposes and that database 238 may include any number of database entries. Database entries 410, 416, 420 may include a similar or identical arrangement to database entry 400. However for ease of presentation, the remainder of the detailed description refers to database entry 400. According to various embodiments, one or more database entries may be added to or deleted from database 238.

Database entry 400 may store an index 402 and data structures 406, 408 associated with the index. The data structures associated with the index may be previously determined based on the PSR of the textual programming language.

FIG. 4B illustrates an exemplary flowchart illustrating processing acts for generating and displaying input suggestions using database 238. Processing acts of FIG. 4B are further described herein referencing the components of development environment 200 and logic 234 illustrated in FIGS. 2A, 2B and 4A.

As provided in FIG. 4B, a user may interact with a textual programming language using development environment 200. Development environment 200 may provide CLI 205 including a first field 202 and a second field 204, where the second field 204 is related to the first field 202 (block 450). A user entry for the first field 202 may be received at CLI 205 (block 452). Logic 234 may parse the user entry for the first field 202 (block 454). Upon parsing the user entry, logic 234 may determine if the user entry matches index 402 in database 238 (block 456). Upon determining a match between the user entry and a database index, logic 234 may retrieve the database entry corresponding to the determined database index. For example, if logic 234 determines that the user entry in first field 202 matches, for example, index 402 of database entry 400, logic 234 may retrieve database entry 400 from database 238. Database entry 400 indicates that data structures 406, 408 are associated with index 402. Thus, logic 234 may generate a first menu of input suggestions 224, 226 for the second field 204 using data structures 406, 408 (block 458). A first GUI 222 of input suggestions 224, 226 for second field 204 may be displayed (block 460).

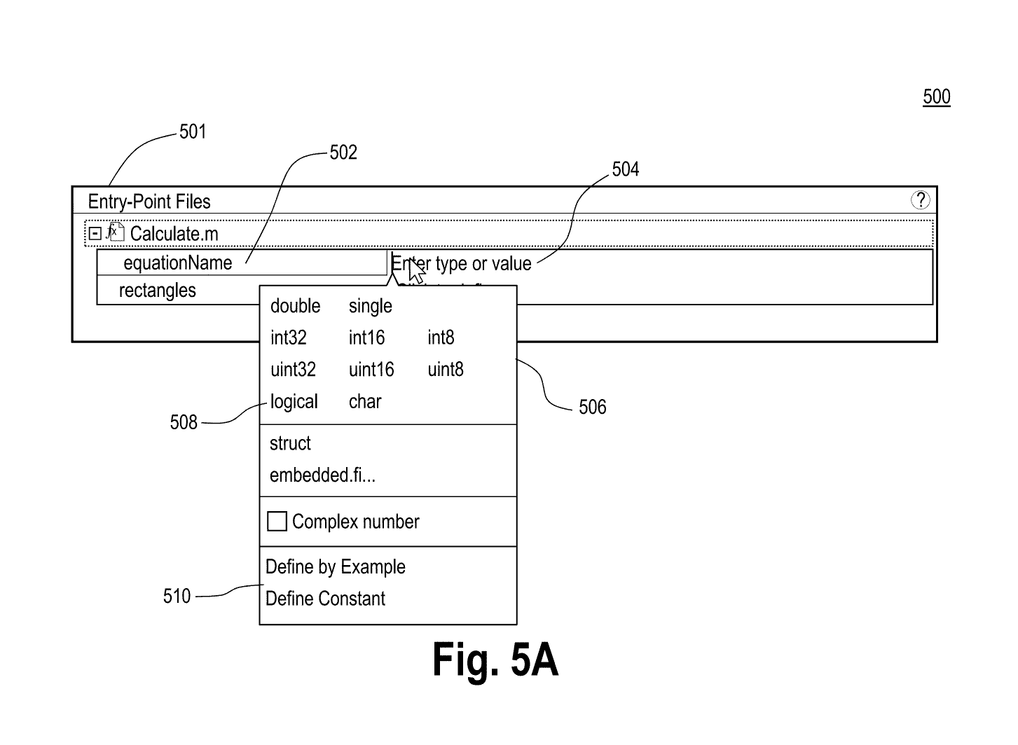

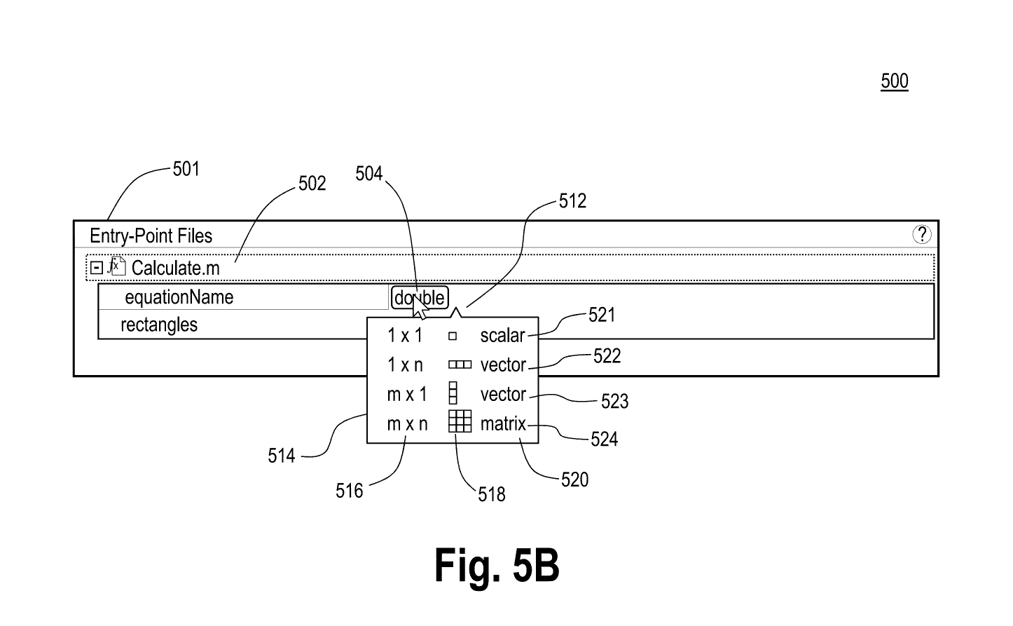

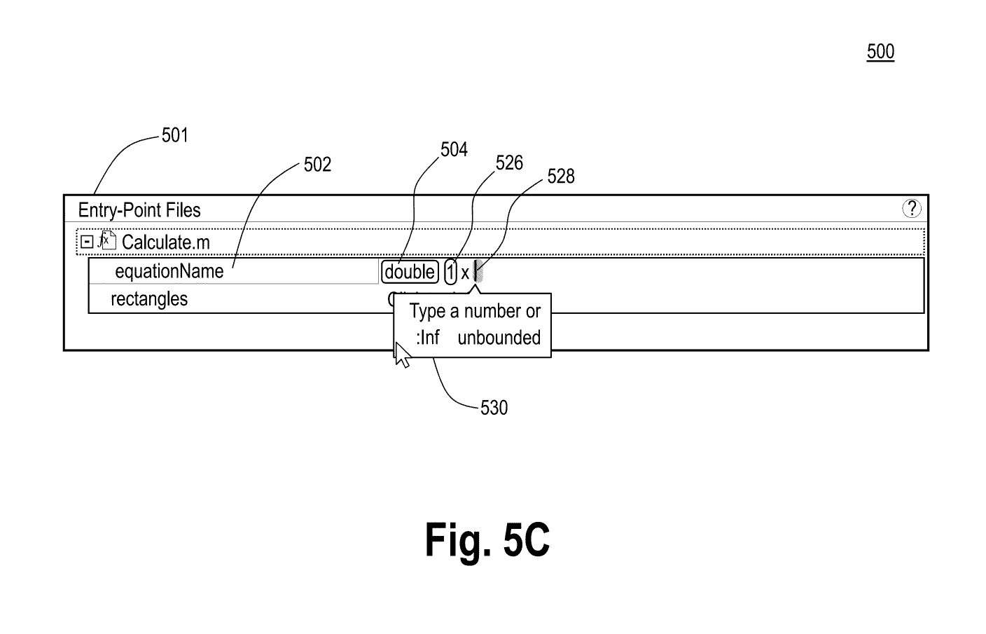

Embodiments may provide GUIs having different layouts for various interrelated fields based on a logical context of the input suggestions provided in respective GUIs. FIGS. 5A-5C illustrate three GUIs with three respective layouts that are generated for interrelated fields of a development environment based on, for example, the logical context of the development environment.

FIG. 5A illustrates an exemplary development environment providing a GUI including input suggestions in connection with a programming language. Exemplary development environment 500 may provide a CLI 501 with at least a first field 502 and a second field 504. Second field 504 may be related to first field 502 in that the content of second field 504 may depend on the content of first field 502. The user may provide an entry in first field 502, such as an equation name.

Based on the entry in first field 502, logic 234 associated with development environment 500, may determine that the user is trying to enter an equation. Based on the PSR of the programming language, it may be determined that an equation name must be followed by a generic data type or a value. In light of the determination, an input suggestion that complies with the PSR of the programming language may be generated and displayed using a GUI 506.

For example, GUI 506 illustrated in FIG. 5A may provide the input suggestions. Input suggestions displayed in GUI 506 may include one or more generic data types 508 that may be entered in second field 504. Embodiments may allow an input suggestion, among one or more generic data types 508, to be selected and entered in second field 504 associated with GUI 506. The input suggestions displayed in GUI 506 may also include one or more options 510 that describe acceptable entries that can be provided in second field 504. For example, options 510 may include an example or a description pertinent to second field 504. The user may choose an option provided in GUI 506 to populate second field 504. Alternatively, the user may discard options provided in GUI 506 and type a free-from text entry for second field 504.

In various embodiments, the logic may prevent the user from providing an entry that does not satisfy the PSR of the programming language. For example, the user may be provided with an error message explaining why a free form entry is rejected, and the user may be instructed to provide an alternative entry that satisfies the PSR of the programming language.

According to various embodiments, input suggestions provided in connection with a field may indicate a data type that may be entered in the field. Based on the provided input suggestions, the user may enter a value that matches at least one of the data types provided in the input suggestions. That is, the user may not be able to directly select one of the provided input suggestions but rather may provide a free-form text that matches at least one of the data types provided in the input suggestions.

FIG. 5B illustrates CLI 501 of development environment 500 where an entry is provided for second field 504. The entry may be entered by a user or provided by the system. CLI 501 may include a third field 512 that is related to second field 504. That is, the entry in second field 504 may impose a specific format on third field 512 based on the PSR of the programming language. Based on the entry in second field 504, a GUI 514 of input suggestions 516 may be displayed in connection with third field 512. GUI 514 may show input suggestions that may be entered in third field 512 and that have a data type of “double” as entered in second field 504. For example, input suggestions 516 may indicate that third field 512 may accept an array that is one of a scalar, a line-vector, a column-vector or a matrix. Input suggestions 516 provided in GUI 514 may further be defined graphically, e.g. using graphical symbols 518, or textually, e.g. using textual descriptions 520. Graphical symbols 518 and/or textual descriptions 520 may assist the user in deciding to select a desired entry for a given field.

In some embodiments, input suggestions 516 provided in GUI 514 may be ordered based on graphical symbols 518 rather than being ordered in an alphabetical order or a usage-frequency order. Accordingly, in various embodiments, GUIs having different layouts may be generated for one or more fields of the development environment. For example, GUI 514 illustrated in FIG. 5B has a different layout than that of GUI 506 illustrated in FIG. 5A. GUI 514 provides data types of the entry that will be provided in third field 512. Input suggestions 516 provided in GUI 514 are further illustrated with graphical symbols 518. Such graphical symbols 518 may not be used if the items in the GUI are not suitable to be graphically represented using visual cues.

For example, as illustrated in FIG. 5B, a first input suggestion 521 for third field 512 may be a scalar, which may be graphically illustrated as a single element. A second input suggestion 522 for third field 512 may be an array such as 1-by-n vector, which may be graphically illustrated as a horizontal line with two or more elements. A third input suggestion 523 for third field 512 may be an array such as m-by-1 vector, which may be graphically illustrated as a vertical line with two or more elements. A fourth input suggestion 524 for third field 512 may be m-by-n matrix which may be graphically illustrated as a grid. Graphical symbols 518 associated with the input suggestions 516 may provide visual help that illustrates the differences between available input suggestions 516.

In FIG. 5B, third field 512 is illustrated as an implicit field that does not have a visible demarcation line in CLI 501. In other embodiments, third field 512 may be an explicit field illustrated with a visible demarcation line.

FIG. 5C illustrates fourth field 526 as an explicit field that has a dedicated shaded area on CLI 501. One of ordinary skill in the art will appreciate that an explicit field may be illustrated using a variety of visual cues, including but not limited to, lines, coloring, shading, hashing, blinking cursor, etc.

A field may be formatted based on structural requirements of the selected input suggestion when the user selects an input suggestion for a field from a GUI. For example, in FIG. 5B, if the user selects second input suggestion 522 for third field 512, third field 512 may be formatted to include two fields with the first field containing the value “1”.

FIG. 5C illustrates third field 512 being formatted to include two fields 526, 528. Field 526 is already populated with value “1” based on the user selecting second input suggestion 522 from GUI 514. Based on the PSR of the programming language, the user should provide another entry in field 528 that will complete the definition of the line vector illustrated in second input suggestion 522. For example, the user may either enter a value in field 528 or indicate that the line vector is an unbounded line vector. The input suggestions may be presented using GUI 530. GUI 530 may instruct the user on what to type in field 528. For example, rather than providing one or more selectable input suggestions such as GUI 506 or illustrating the structure of data that may be entered in the associated field such as GUI 514, GUI 530 instructs the user to either type a number or a string of characters indicating that the vector will be unbounded.

GUI 530 illustrated in FIG. 5C has a different layout than that of GUI 506 and GUI 514. GUI 530 includes instructions regarding what should be entered in field 528. Accordingly, the layout of a GUI providing input suggestions may be determined based on, for example, the input requirements of the field associated with the GUI. In other embodiments, a standard layout may be used for all GUIs displayed in the development environment.

Various embodiments may provide one or more backward input suggestions for replacing an entry in a field after the user selects or provides the entry to populate the field. The backward input suggestions may be provided to present possible alternatives to the user entry. In some embodiments, the backward input suggestions may be provided when the user entry fails to comply with PSR of the programming language. If the user selects one of the backward input suggestions, the entry may be replaced with the selected backward input suggestion.

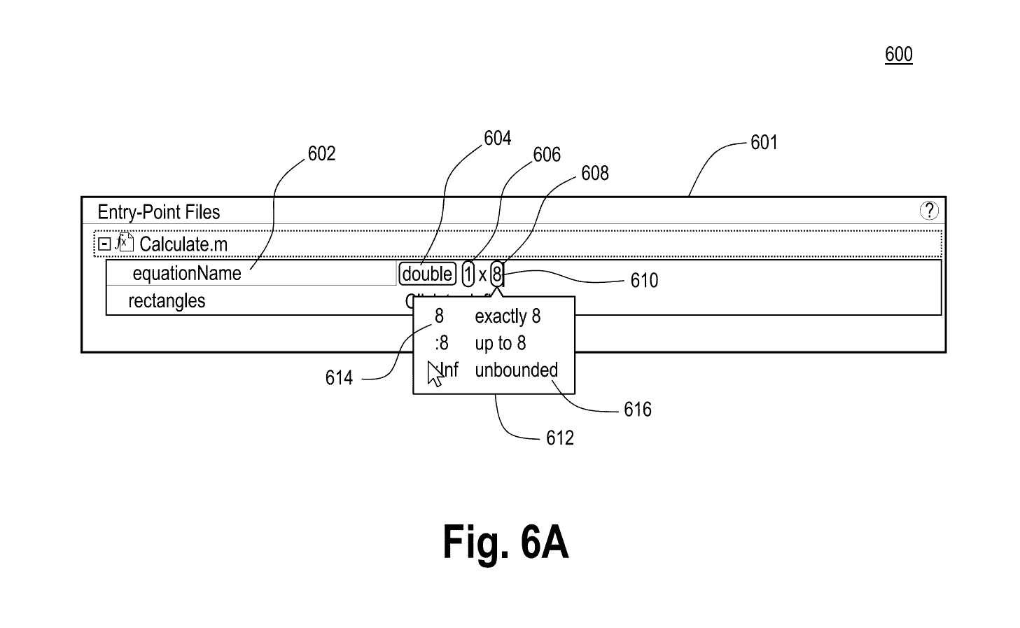

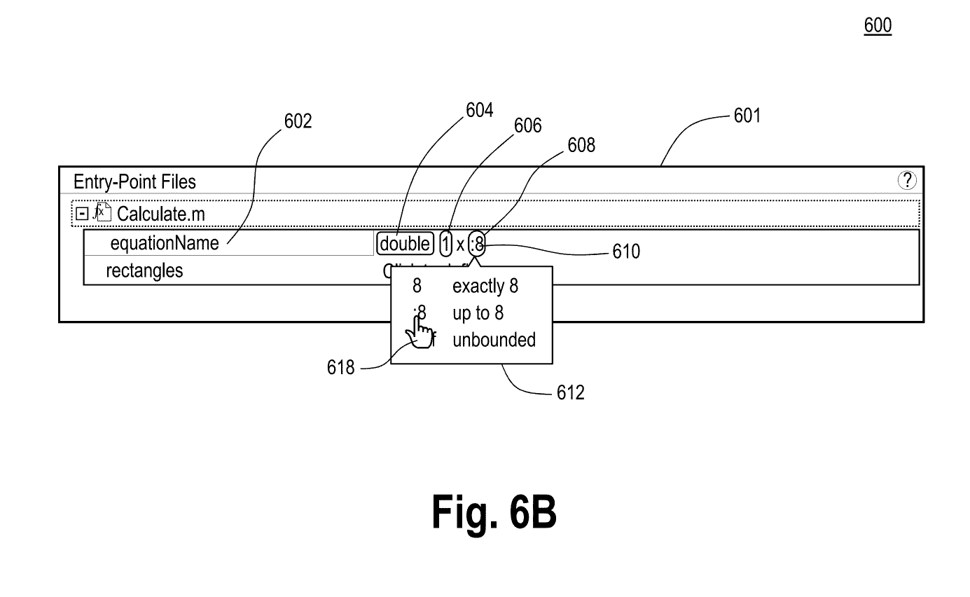

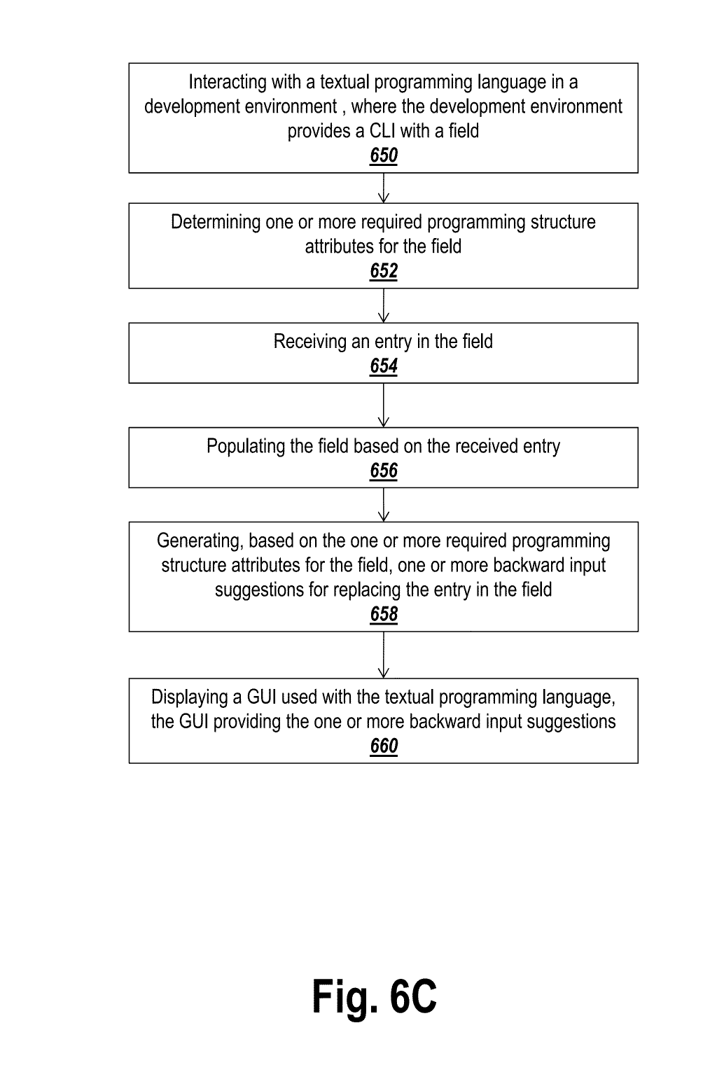

FIG. 6A illustrates a GUI providing one or more backward input suggestions in an exemplary development environment. The exemplary development environment 600 may provide a CLI 601 with at least fields 602, 604, 606 and 608 all of which are populated with respective entries. The user may select a field by, for example, pointing to the field using a cursor, and one or more backward input suggestions may be provided in connection with the selected field.

For example, the user may select field 608 and a GUI 612 of backward input suggestions 614 may be provided based on entry 610 in field 608. One of ordinary skill in the art will appreciate that backward suggestions may be provided in connection with any field of the development environment. The user may have entered a value, e.g. “8”, in field 608. However, based on the PSR of the programming language associated with development environment 600, other entry options for field 608 may include values up to 8 represented by providing a colon in front of the value 8 or an unbounded value represented by the string of characters “:Inf”. Logic 234 associated with development environment 600 may parse entry 610 in field 608 using parser 235, for example, from left to right. When the parsed entry is recognized as the number “8”, other input suggestions such as “:8” and “:Inf” may be generated based on the entry for field 608.

Upon parsing entry 610 in field 608, logic 234 may retrieve input suggestions for field 608 from a database, for example database 238 illustrated in FIG. 4. Backward input suggestions 614 may be provided along with respective textual explanation 616 of each input suggestion. In some embodiments, the user may discard backward input suggestions 614 provided in GUI 612 and proceed with entry 610 in field 608. Alternatively, as illustrated in FIG. 6B, the user may select one of backward input suggestions 614, such as “:8” backward suggestion using a pointing device 618, to replace entry 610 in field 608. Upon selection of a backward suggestion, entry 610 in field 608 may be replaced with the selected entry from GUI 612.

FIG. 6C illustrates an exemplary flowchart describing how one or more backward input suggestions are generated and displayed in connection with a textual programming language. In development environment 600, a user may interact with a textual programming language. Development environment 600 may provide a CLI 601 with a first field 608 (block 650). One or more required programming structure attributes of field 608 may be determined (block 652). The one or more required programming structure attributes of field 608 may be imposed by the PSR of the textual programming language. An entry 610 for field 608 may be received at the development environment 600 (block 654). The field 608 may be populated based on received entry 610 (block 656). One or more backward input suggestions 614 may be generated based on the one or more required programming structure attributes for the field 608 (block 658). GUI 612 may be displayed to provide the one or more backward input suggestions 614 (block 660). The one or more backward input suggestions 614 may be provided for replacing entry 610 in field 608.

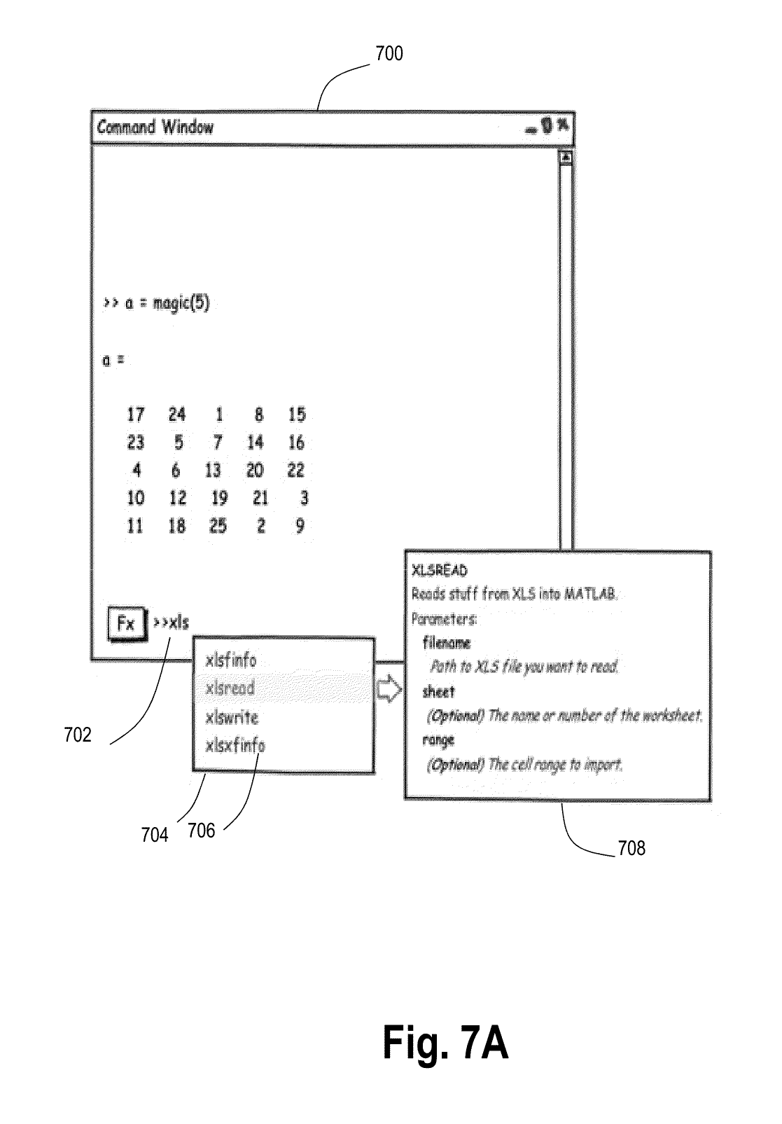

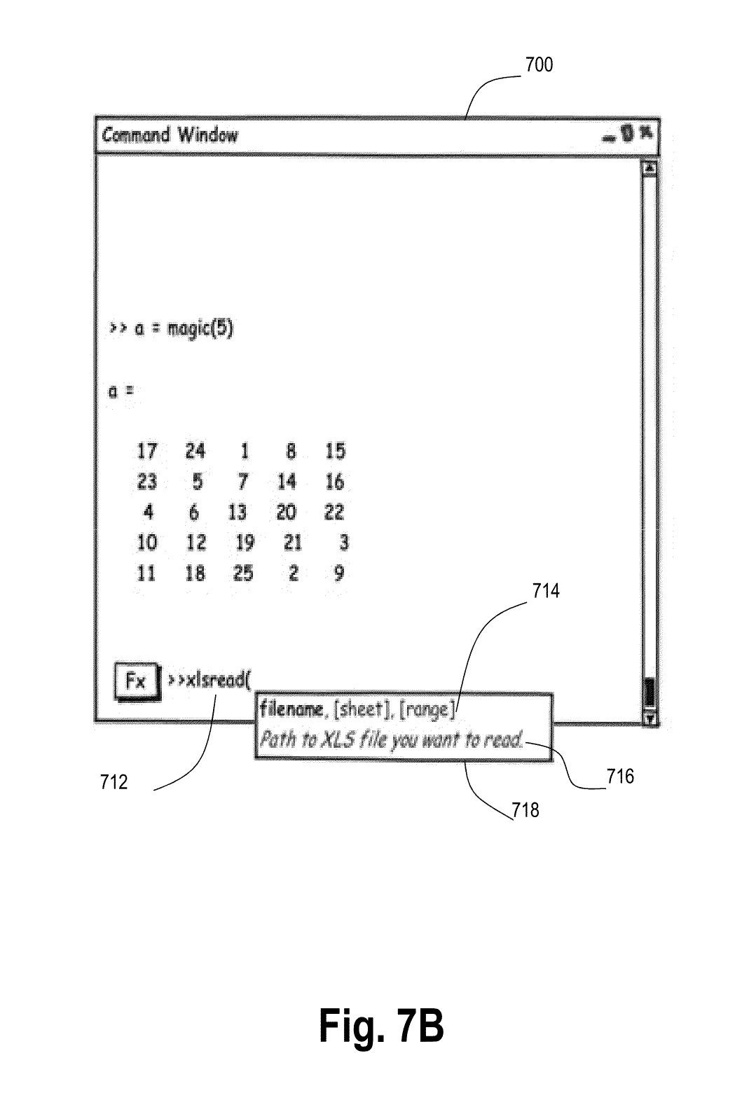

In various embodiments, input requirements that satisfy the PSR of the textual programming language may be provided when the user types a programming structure. FIG. 7A illustrates a GUI containing information for providing explanation of input requirements for a selected programming structure. A user may start typing a programming structure 702, such as a function name. Before the user enters the complete programming structure, a list of matching programming structures 706 may be provided in a first GUI 704.

The user may select a matching programming structure in first GUI 704. Based on the selection in first GUI 704, a second GUI 708 may be provided explaining input requirements for the selected programming structure. In the example of FIG. 7A, when the user enters the characters “xls”, first GUI 704 provides a list of functions whose name start with the string of characters “xls”. When the user selects the “xlsread” function from first GUI 704, second GUI 708 provides an overview of the selected function along with information identifying types of parameters that should follow the selected function.

In the example illustrated in FIG. 7B, when the user enters function name 712 (e.g., by making a selection using a cursor), GUI 718 of input suggestions 714 may be provided in connection with the function name 712. For example, when the user enters “xlsread”, GUI 718 provides a list of input parameters that must follow the selected function in accordance with the PSR of the textual programming language. A textual explanation 716 for an input suggestion 714 may also be provided in GUI 718. For example, textual explanation 716 may be provided when an input suggestion 714 is selected. In the example illustrated in FIG. 7B, input suggestion “filename” is selected. The explanation of the “filename” parameter is provided in GUI 718 as “path to XLS file you want to read.”

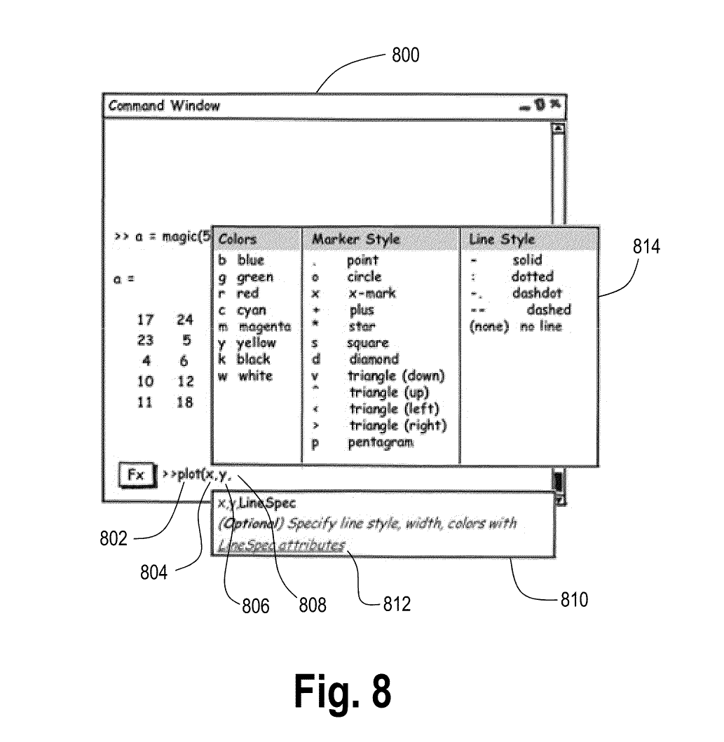

FIG. 8 illustrates an exemplary development environment 800 where the user may enter a programming structure, such as function 802, and arguments associated with the programming structure, such as variable 804 and variable 806. A first GUI 810 may provide input suggestions associated with function 802. For example, first GUI 810 may display an overview of function 802, such as what types of arguments should be provided for function 802. Since the user already provided variables 804, 806 for the first two arguments, input suggestions associated with subsequent argument 808 may be provided in first GUI 810. First GUI 810 may have a hyperlink 812 that, when activated, displays a second GUI 814 that provides additional input suggestions for argument 808. Second GUI 814 may display the input suggestions for argument 808 in the form of a table.

As illustrated in FIG. 8, argument 808 of function 802 is an argument that allows the user to specify graphical properties of a plot. GUI 814 may group the input suggestions for argument 808 according to various attributes, such as, color, marker style and line style. One of ordinary skill in the art will appreciate that the use of a table to display the input suggestions is for illustration purposes only and that the input suggestions may be displayed in any suitable format. In various embodiments, layout designs based on types of device displays (e.g., mobile phone display, desktop computer display, etc.), types of expected input suggestions, computational nature of a computing application, etc.

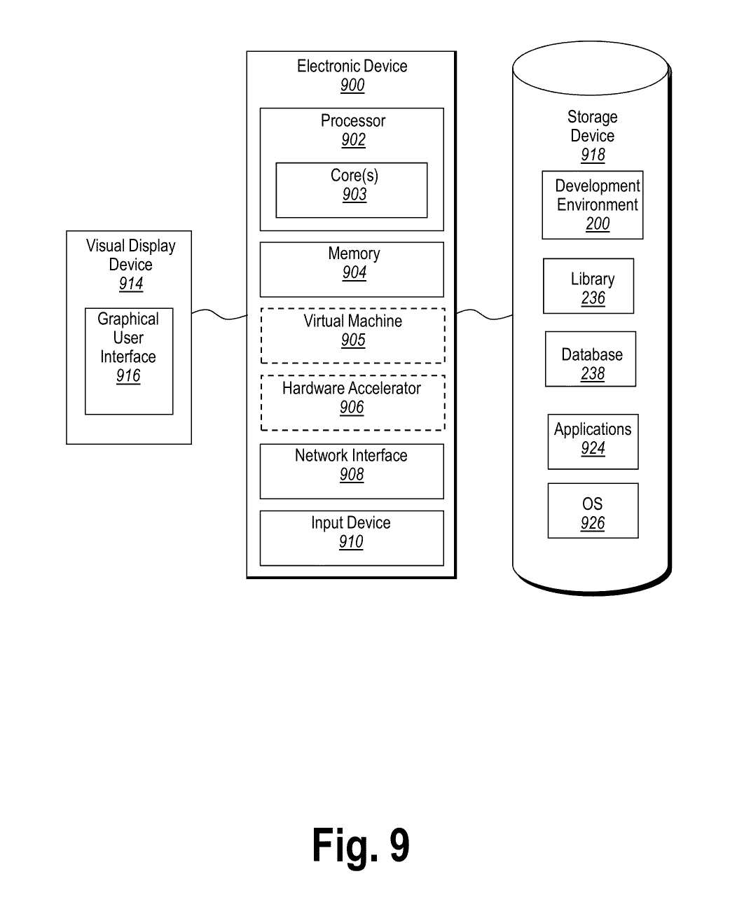

One or more of the above-described acts may be encoded as computer-executable instructions executable by processing logic, e.g., in a programmed electronic device. The computer-executable instructions may be stored on one or more non-transitory computer readable media. FIG. 9 depicts an example of an electronic device 900 that may be suitable for use with one or more acts disclosed herein. For example, electronic device 900 may retrieve executable instructions from a computer-readable media and may execute the instructions using a processing device to perform one or more operations for implementing aspects of exemplary embodiments described herein.

Electronic device 900 is illustrative and may take other forms, including but not limited to a computing device, computer, workstation, server, network computer, optical computer, Internet appliance, mobile device, a tablet computer, application specific processing device, etc. For example, an alternative implementation of electronic device 900 may have fewer components, more components, or components that are in a configuration that differs from the configuration of FIG. 9. The components of FIG. 9 and/or other figures described herein may be implemented using hardware based logic, and/or logic that is a combination of hardware and software based logic (e.g., hybrid logic); therefore, components illustrated in FIG. 9 and/or other figures are not limited to a specific type of logic.

Processor 902 may include hardware based logic or a combination of hardware based logic and software to execute machine-readable instructions on behalf of electronic device 900. Processor 902 may include logic that may interpret, execute, and/or otherwise process information contained in, for example, memory 904. The information may include computer-executable instructions and/or data that may implement one or more embodiments of the invention. Processor 902 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor may include a single core or multiple cores 903. Moreover, processor 902 may include a system-on-chip (SoC) or system-in-package (SiP).

Electronic device 900 may include one or more tangible non-transitory computer-readable storage media for storing one or more computer-executable instructions or software that may implement one or more embodiments of the invention. The non-transitory computer-readable storage media may be, for example, memory 904 or storage 918. Memory 904 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

One or more electronic devices 900 may include a virtual machine (VM) 905 for executing the instructions loaded in memory 904. A virtual machine 905 may be provided to handle a process running on multiple processors so that the process may appear to be using only one computing resource rather than multiple computing resources. Virtualization may be employed in electronic device 900 so that infrastructure and resources in electronic device 900 may be shared dynamically. Multiple VMs 905 may be resident on a single electronic device 900.

A hardware accelerator 906, may be implemented in an ASIC, FPGA, or some other device. Hardware accelerator 906 may be used to reduce the general processing time of electronic device 900.

Electronic device 900 may include a network interface 908 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. Network interface 908 may include a built-in network adapter, network interface card, personal computer memory card international association (PCMCIA) network card, card bus network adapter, wireless network adapter, universal serial bus (USB) network adapter, modem or any other device suitable for interfacing electronic device 900 to any type of network capable of communication and performing the operations described herein.

Electronic device 900 may include one or more input devices 910, such as a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 900 may include other suitable I/O peripherals.

Input devices 910 may allow a user to provide input that is registered on a display device 914. A graphical user interface (GUI) 916 may be shown on display device 914.

A storage device 918 may also be associated with electronic device 900. Storage device 918 may be accessible to processor 902 via an I/O bus. The information may be executed, interpreted, manipulated, and/or otherwise processed by processor 902. Storage device 918 may include, for example, a storage device, such as a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

Storage device 918 may be used for storing application software programs, such as a development environment 200 including a hybrid graphical/textual modeling environment (which may be, for example, the Simulink® environment) or a textual development environment (which may be, for example, the MATLAB® environment). Storage device 918 may also be used for storing library 236 and database 238 associated with development environment 200.

Development environment 200 may be part of a technical computing environment (TCE). A TCE may include hardware and/or software based logic that provides a computing environment that allows users to perform tasks related to disciplines, such as, but not limited to, mathematics, science, engineering, medicine, business, etc., more efficiently than if the tasks were performed in another type of computing environment, such as an environment that required the user to develop code in a conventional programming language, such as C++, C, Fortran, Java, etc.

In one implementation, the TCE may include a dynamically typed language that can be used to express problems and/or solutions in mathematical notations familiar to those of skill in the relevant arts. For example, the TCE may use an array as a basic element, where the array may not require dimensioning. In addition, the TCE may be adapted to perform matrix and/or vector formulations that can be used for data analysis, data visualization, application development, simulation, modeling, algorithm development, etc. These matrix and/or vector formulations may be used in many areas, such as statistics, image processing, signal processing, control design, life sciences modeling, discrete event analysis and/or design, state based analysis and/or design, etc.

The TCE may further provide mathematical functions and/or graphical tools (e.g., for creating plots, surfaces, images, volumetric representations, etc.). In one implementation, the TCE may provide these functions and/or tools using toolboxes (e.g., toolboxes for signal processing, image processing, data plotting, parallel processing, etc.). In another implementation, the TCE may provide these functions as block sets. In still another implementation, the TCE may provide these functions in another way, such as via a library, etc. The TCE may be implemented as a text based environment, a graphically based environment, or another type of environment, such as a hybrid environment that is both text and graphically based.

Storage device 918 may further store applications 924, and electronic device 900 can be running an operating system (OS) 926. Examples of OS 926 may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device and performing the operations described herein. The operating system may be running in native mode or emulated mode. Storage device 918 may also store templates associated with applications 924. The templates associated with applications 924 may be combined and the combination applied to a file or a file storage structure created using applications 924, as discussed herein.

One or more embodiments of the invention may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

One or more embodiments of the invention may be implemented in a programming language. Some examples of languages that may be used include, but are not limited to, Python, C, C++, C#, SystemC, Java, Javascript, a hardware description language (HDL), unified modeling language (UML), and Programmable Logic Controller (PLC) languages. Further, one or more embodiments of the invention may be implemented in a hardware description language or other language that may allow prescribing computation. One or more embodiments of the invention may be stored on or in one or more mediums as object code. Instructions that may implement one or more embodiments of the invention may be executed by one or more processors. Portions of the invention may be in instructions that execute on one or more hardware components other than a processor.

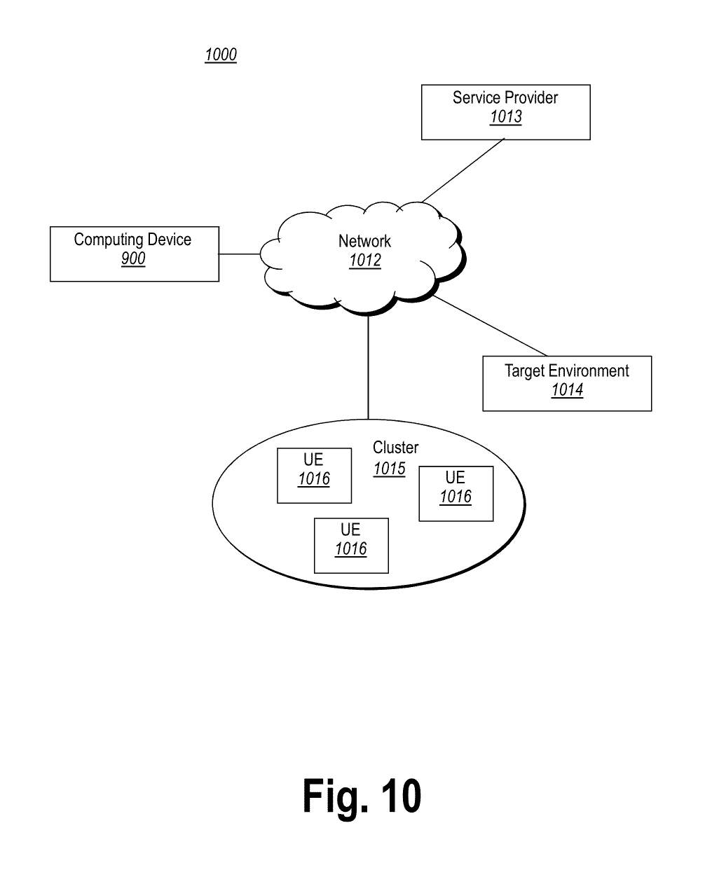

FIG. 10 depicts a network implementation that may implement one or more embodiments of the invention. A system 1000 may include a electronic device 900, a network 1012, a service provider 1013, a target environment 1014, and a cluster 1015. The embodiment of FIG. 10 is exemplary, and other embodiments can include more devices, fewer devices, or devices in arrangements that differ from the arrangement of FIG. 10.

Network 1012 may transport data from a source to a destination. Embodiments of network 1012 may use network devices, such as routers, switches, firewalls, and/or servers (not shown) and connections (e.g., links) to transport data. Data may refer to any type of machine-readable information having substantially any format that may be adapted for use in one or more networks and/or with one or more devices (e.g., electronic device 900, service provider 1013, etc.). Data may include digital information or analog information. Data may further be packetized and/or non-packetized.

Network 1012 may be a hardwired network using wired conductors and/or optical fibers and/or may be a wireless network using free-space optical, radio frequency (RF), and/or acoustic transmission paths. In one implementation, network 1012 may be a substantially open public network, such as the Internet. In another implementation, network 1012 may be a more restricted network, such as a corporate virtual network. Network 1012 may include Internet, intranet, Local Area Network (LAN), Wide Area Network (WAN), Metropolitan Area Network (MAN), wireless network (e.g., using IEEE 802.11), or other type of network The network 912 may use middleware, such as Common Object Request Broker Architecture (CORBA) or Distributed Component Object Model (DCOM). Implementations of networks and/or devices operating on networks described herein are not limited to, for example, any particular data type, protocol, and/or architecture/configuration.

Service provider 1013 may include a hardware device that makes a service available to another device. For example, service provider 1013 may include an entity (e.g., an individual, a corporation, an educational institution, a government agency, etc.) that provides one or more services to a destination using a server and/or other devices. Services may include instructions that are executed by a destination to perform an operation (e.g., an optimization operation). Alternatively, a service may include instructions that are executed on behalf of a destination to perform an operation on the destination's behalf.

Target environment 1014 may include a device that receives information over network 1012. For example, target environment 1014 may be a device that receives user input from electronic device 900.

Cluster 1015 may include a number of units of execution (UEs) 1016 and may perform processing on behalf of electronic device 900 and/or another device, such as service provider 1013. For example, cluster 1015 may perform parallel processing on an operation received from electronic device 900. Cluster 1015 may include UEs 1016 that reside on a single device or chip or that reside on a number of devices or chips.

Units of execution (UEs) 1016 may include processing devices that perform operations on behalf of a device, such as a requesting device. A UE may be a microprocessor, field programmable gate array (FPGA), and/or another type of processing device. UE 1016 may include code, such as code for an operating environment. For example, a UE may run a portion of an operating environment that pertains to parallel processing activities. Service provider 1013 may operate cluster 1015 and may provide interactive optimization capabilities to electronic device 900 on a subscription basis (e.g., via a web service).

Units of Execution (UEs) may provide remote/distributed processing capabilities for products such as MATLAB® from The MathWorks, Inc. A hardware unit of execution may include a device (e.g., a hardware resource) that may perform and/or participate in parallel programming activities. For example, a hardware unit of execution may perform and/or participate in parallel programming activities in response to a request and/or a task it has received (e.g., received directly or via a proxy). A hardware unit of execution may perform and/or participate in substantially any type of parallel programming (e.g., task, data, stream processing, etc.) using one or more devices. For example, a hardware unit of execution may include a single processing device that includes multiple cores or a number of processors. A hardware unit of execution may also be a programmable device, such as a field programmable gate array (FPGA), an application specific integrated circuit (ASIC), a digital signal processor (DSP), or other programmable device. Devices used in a hardware unit of execution may be arranged in many different configurations (or topologies), such as a grid, ring, star, or other configuration. A hardware unit of execution may support one or more threads (or processes) when performing processing operations.

A software unit of execution may include a software resource (e.g., a technical computing environment) that may perform and/or participate in one or more parallel programming activities. A software unit of execution may perform and/or participate in one or more parallel programming activities in response to a receipt of a program and/or one or more portions of the program. A software unit of execution may perform and/or participate in different types of parallel programming using one or more hardware units of execution. A software unit of execution may support one or more threads and/or processes when performing processing operations.

The term ‘parallel programming’ may be understood to include multiple types of parallel programming, e.g. task parallel programming, data parallel programming, and stream parallel programming. Parallel programming may include various types of processing that may be distributed across multiple resources (e.g., software units of execution, hardware units of execution, processors, microprocessors, clusters, labs) and may be performed at the same time.

For example, parallel programming may include task parallel programming where a number of tasks may be processed at the same time on a number of software units of execution. In task parallel programming, a task may be processed independently of other tasks executing, for example, at the same time.

Parallel programming may include data parallel programming, where data (e.g., a data set) may be parsed into a number of portions that may be executed in parallel using, for example, software units of execution. In data parallel programming, the software units of execution and/or the data portions may communicate with each other as processing progresses.

Parallel programming may include stream parallel programming (sometimes referred to as pipeline parallel programming). Stream parallel programming may use a number of software units of execution arranged, for example, in series (e.g., a line) where a first software unit of execution may produce a first result that may be fed to a second software unit of execution that may produce a second result given the first result. Stream parallel programming may also include a state where task allocation may be expressed in a directed acyclic graph (DAG) or a cyclic graph.

Other parallel programming techniques may involve some combination of task, data, and/or stream parallel programming techniques alone or with other types of processing techniques to form hybrid-parallel programming techniques.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of a electronic device, unless otherwise stated.

1. A computer-implemented method comprising:
interacting with, using a computing device, a textual programming language associated with an interface, where:
the interface provides:
a first field, and
a second field, where the second field is related to the first field;
receiving an entry for the first field, the receiving:
performed via the interface, and
performed using the computing device;
processing, using the computing device, the received entry for the first field;
determining, using the computing device, one or more programming structure attributes for the second field, the determining based on:
a programming structure requirement of the textual programming language, and
the processing of the received entry for the first field;
generating, based on the processing and the determining, a first graphical user interface (GUI), the first GUI comprising one or more input suggestions for the second field, where:
the one or more input suggestions for the second field comply with the one or more required programming structure attributes for the second field, and
the generating performed using the computing device; and
displaying the first GUI.

2. The method of claim 1, wherein the interface is a command line interface (CLI) provided in a development environment.

3. The method of claim 1, wherein the interface is provided in a spreadsheet application.

4. The method of claim 1, wherein the first GUI is displayed when the second field is empty.

5. The method of claim 1, further comprising:
receiving a selection, the selection identifying one of the one or more input suggestions; and
populating the second field based on the received selection.

6. The method of claim 1, further comprising:
receiving a selection, the selection identifying one of the one or more input suggestions; and
formatting the second field based on the received selection.

7. The method of claim 6, wherein the formatting further comprises:
displaying one or more graphical indicators for one or more inputs available for the second field.

8. The method of claim 1, further comprising:
receiving a free-form textual input, the free-form textual input differing from the one or more input suggestions displayed using the first GUI;
processing the received free-form textual input; and
populating the second field with an entry based on the processing the received free-form textual input.

9. The method of claim 8, further comprising:
displaying a second GUI comprising one or more backward input suggestions, the one or more backward input suggestions for replacing the entry in the second field.

10. The method of claim 1, further comprising:
receiving a free-form textual input, the free-form textual input differing from the one or more input suggestions displayed using the first GUI;
processing the received free-form textual input; and
rejecting the received free-form textual input when one or more attributes of the received free-form textual input fails to match the one or more required programming structure attributes of the second field.

11. The method of claim 1, wherein the one or more input suggestions are graphically represented.

12. The method of claim 1, further comprising:
selecting the entry in the first field; and
providing a second GUI of one or more backward suggestions, the one or more backward input suggestions for replacing the entry in the first field.

13. The method of claim 1, further comprising:
displaying a third field, the third field related to the first field or the second field
selecting the third field; and
displaying a third GUI comprising one or more input suggestions for the third field.

14. The method of claim 11, further comprising:
selecting at least one of the one or more input suggestions displayed in the third GUI; and
populating the third field based on the selected at least one of the one or more input suggestions.

15. A computer-implemented method comprising:
interacting with, using a computing device, a textual programming language, where:
a programming structure requirement is associated with the textual programming language;
determining, using the computing device, one or more programming structure attributes for a displayed field, the determining based on the programming structure requirement of the textual programming language;
receiving, at the computing device, an entry in the field;
populating, using the computing device, the field based on the received entry;
generating, based on the one or more programming structure attributes for the field one or more backward input suggestions, the one or more backward input suggestions for replacing the entry in the field when the field is populated based on the received entry, the generating performed using the computing device; and
displaying a graphical user interface (GUI), the GUI providing the one or more backward input suggestions.

16. One or more non-transitory computer-readable media comprising:
one or more instructions that, when executed, cause at least one processing device to:
interact with a textual programming language associated with an interface, where:
the interface provides:
a first field, and
a second field, where the second field is related to the first field;
receive an entry for the first field, the receiving performed via the interface;
process the received entry for the first field;
determine one or more programming structure attributes for the second field, the determining based on:
a programming structure requirement of the textual programming language, and
the processing of the received entry for the first field;
generate, based on the processing and the determining, a first graphical user interface (GUI), the first GUI comprising one or more input suggestions for the second field, where:
the one or more input suggestions for the second field comply with the one or more required programming structure attributes for the second field; and
display the first GUI.

17. The medium of claim 16, wherein the interface is a command line interface provided in a development environment.

18. The medium of claim 16, wherein the interface is provided in a spreadsheet environment.

19. The medium of claim 16, wherein the first GUI is displayed when the second field is empty.

20. The medium of claim 16, further comprising:
one or more instructions that, when executed, cause at least one processing device to:
receive a selection, the selection identifying one of the one or more input suggestions; and
populate the second field based on the received selection.

21. The medium of claim 16, further comprising:
one or more instructions that, when executed, cause at least one processing device to:
receive a free-form textual input, the free-form textual input differing from the one or more input suggestions displayed using the first GUI;
process the received free-form textual input; and
populate the second field with an entry based on the received free-form textual input.

22. The medium of claim 21, further comprising:
one or more instructions that, when executed, cause at least one processing device to:
display a second GUI comprising one or more backward input suggestions, the one or more backward input suggestions for replacing the entry in the second field.

23. The medium of claim 16, further comprising:
one or more instructions that, when executed, cause at least one computing device to:
receive a free-form textual input, the free-form textual input differing from the one or more input suggestions displayed using the first GUI;
process the received free-form textual input; and
reject the received free-form textual input when one or more attributes of the received free-form textual input fails to match the one or more required programming structure attributes of the second field.

24. The medium of claim 16, further comprising:
one or more instructions that, when executed, cause at least one processing device to:
select the entry in the first field; and
provide a second GUI of one or more backward suggestions for replacing the selected entry in the first field.

25. One or more non-transitory computer-readable media comprising:
one or more instructions that, when executed, cause at least one computing device to:
interact with a textual programming language, where:
a programming structure requirement is associated with the textual programming language;
determine one or more programming structure attributes for a displayed field, the determining based on the programming structure requirement of the textual programming language;
receive an entry in the field;
populate the field based on the received entry;
generate, based on the one or more programming structure attributes for the field one or more backward input suggestions, the one or more backward input suggestions for replacing the entry in the field when the field is populated based on the received entry; and
display a graphical user interface (GUI), the GUI providing the one or more backward input suggestions.

26. A system comprising:
a processor executing instructions for:
interacting with a textual programming language associated with an interface, where:
the interface provides:
a first field, and
a second field, where the second field is related to the first field;
receiving an entry for the first field, the receiving performed via the interface;
processing the received entry for the first field;
determining one or more programming structure attributes for the second field, the determining based on:
a programming structure requirement of the textual programming language, and
the processing of the received entry for the first field;
generating, based on the processing and the determining, a first graphical user interface (GUI), the first GUI comprising one or more input suggestions for the second field, where:
the one or more input suggestions for the second field comply with the one
or more required programming structure attributes for the second field; and
a display device for displaying the first GUI.
